(19) United States
(12) Patent Application Publication
(10) Pub. No.: US 2012/0129031 A1
(43) Pub. Date: May 24, 2012

(54) HEAT SINK OF BATTERY CELL FOR ELECTRIC VEHICLES AND BATTERY CELL MODULE USING THE SAME

(75) Inventor: Jin Soo KIM, Osan-si (KR)

(73) Assignee: KOREA COOLER CO., LTD., Pyeongtaek-si (KR)

(21) Appl. No.: 13/295,632

(22) Filed: Nov. 14, 2011

(30) Foreign Application Priority Data
Nov. 22, 2010 (KR) 10-2010-0116049

(51) Int. Cl. H01M 10/50

(52) U.S. Cl. 429/120

(57) ABSTRACT

A heat sink of a battery cell for electric vehicles and a battery cell module using the heat sink are provided to prevent deterioration of battery cells by effectively emitting heat generated from the battery cells. The battery cells are arranged at predetermined intervals and connected in parallel or series to each other. Each of the heat sinks is arranged between the battery cells and radiates heat generated from the battery cells. Each heat sink includes a heat-radiating case attached to at least one side of each battery cell and filled with a first refrigerant, and a second refrigerant circulating pipe arranged in the heat-radiating case and configured to circulate a second refrigerant for cooling the first refrigerant. A first refrigerant filled in the heat-radiating case may also be circulated for a heat exchange.

### BACKGROUND OF THE INVENTION

1. Field of the Invention

The present invention relates to a battery cell module of a vehicle using electricity as a power source, and more particularly, to a heat sink of a battery cell for a vehicle, which is able to effectively emit heat generated from a battery cell module, and a battery cell module using the same.

2. Description of the Related Art

Vehicles (referred to as ‘electric vehicles’ hereinafter) using electricity instead of fossil fuel such as gasoline, diesel, LPG, etc. are increasingly propagated owing to efficient utilization of energy and saving of energy resources. The electric vehicles include an electric car capable of running only using a battery and a hybrid car using a battery with the existing engine, and some of them are commercialized and used. Particularly, the electric vehicles barely cause environmental pollution compared to conventional vehicles using fossil fuel, and thus the use of the electric vehicles are expected to be extended.

The electric vehicles use a secondary battery as a power source. A lead storage battery, a nickel-metal hydride battery, a lithium-ion battery or the like is used as the secondary battery. To use the secondary battery as a power source of the electric vehicles, the secondary battery needs to output high power. Accordingly, a plurality of small secondary batteries is connected in series or parallel to form a battery cell and a plurality of battery cells is connected in parallel or series to form one battery cell module which is used as the power source of the electric vehicles.

Since the battery cell module generates a large amount of heat during its charging and discharging processes, heat accumulation occurs in the battery cell module to deteriorate the battery cells if the heat generated during the charging and discharge processes is not effectively eliminated. The deterioration of the battery cells reduces the expected lifespan of the battery cell module and, in extreme cases, plays a role as a leading cause of ignition or explosion. Accordingly, a cooling system is needed which is able to effectively emit the heat generated during the charging and discharging processes of the battery cell module to prevent the battery cell module from deterioration.

The battery cell module is generally cooled by employing an air-cooling structure using air, which inhales the air outside or inside an electric vehicle to cool the battery cell of the electric vehicle and then discharges the air to the outside of the electric vehicle.

However, there is a limit in cooling the battery cell module using the air. When the electric vehicle stops, particularly, air circulation is not smoothly performed, and thus it is difficult to effectively emit the heat generated from the battery cell module to cool the battery cell module.

### BRIEF SUMMARY OF THE INVENTION

An object of the present invention is to provide a heat sink of a battery cell for electric vehicles, which is able to effectively emit heat generated from the battery cell to restrain deterioration of the battery cell, and a battery cell module using the same.

It will be appreciated by person skilled in the art that the objects that could be achieved with the present invention are not limited to what has been particularly described hereinabove and the above and other objects that the present invention could achieve will be more clearly understood from the following detailed description.

According to one aspect of the present invention, provided is a heat sink of a battery cell having a plate shape for electric vehicles. The heat sink comprises a heat-radiating case attached to at least one side of the battery cell and filled with a first refrigerant, and a second refrigerant circulating pipe arranged in the heat-radiating case and configured to circulate a second refrigerant for cooling the first refrigerant.

The heat sink may further comprise a plurality of supports located between the inner side of the heat-radiating case and the second refrigerant circulating pipe and discontinuously arranged along the second refrigerant circulating pipe to support the second refrigerant circulating pipe.

The heat sink may further comprise a plurality of supports located between the inner side of the heat-radiating case and the second refrigerant circulating pipe and discontinuously arranged along the second refrigerant circulating pipe to support the second refrigerant circulating pipe.

In the heat sink, the first and second refrigerants may include at least one of air, water, antifreeze, antifreeze-added water, a Freon refrigerant, a natural refrigerant, and a liquefied gas.

In the heat sink, the second refrigerant circulating pipe may include an inlet through which the second refrigerant is injected, a cooling pipe connected to the inlet and arranged in the heat-radiating case, wherein a heat exchange occurs between the second refrigerant injected through the inlet and the first refrigerant filled in the heat-radiating case, and an outlet connected to the cooling pipe and allowing the second refrigerant passing through the cooling pipe to be discharged to the outside of the heat-radiating case.

The heat sink may further comprise a first refrigerant circulating pipe configured to circulate the first refrigerant filled in the heat-radiating case.

In the heat sink, the first refrigerant circulating pipe may include an inlet connected to the heat-radiating case and allowing the first refrigerant to be injected into the heat-radiating case, and an outlet connected to the heat-radiating case and allowing the first refrigerant to be discharged to the outside of the heat-radiating case.

In the heat sink, a circulation speed of the second refrigerant may be higher than that of the first refrigerant.

According to another aspect of the present invention, provided is a battery cell module for electric vehicles. The battery cell module comprises a plurality of battery cells arranged at predetermined intervals and connected in parallel or series to each other, and a plurality of heat sinks each of which is arranged between the battery cells. Each of the heat sinks includes a heat-radiating case attached to at least one side of each battery cell and filled with a first refrigerant, and a second refrigerant circulating pipe arranged in the heat-radiating case and configured to circulate a second refrigerant for cooling the first refrigerant.

The battery cell module may further comprise a heat exchanger connected to the heat sinks, configured to circulate the second refrigerant, and performing a heat exchange for the circulated second refrigerant.

The battery cell module may further comprise a first refrigerant circulating pipe configured to circulate the first refrigerant filled in the heat-radiating case, wherein the heat exchanger performs a heat exchange for the first refrigerant.

According to aspects of the present invention, a heat sink is located between neighboring battery cells and uses a plurality of refrigerants to absorb heat generated from the battery cells and rapidly radiate the absorbed heat, thereby preventing the battery cells from deterioration. That is, the heat sink has a structure in which a first refrigerant is filled in a heat-radiating case and a flow path through which a second refrigerant is circulated is formed according to a second refrigerant circulating pipe in the heat-radiating case, and thus heat generated from the battery cells is transferred to the first refrigerant through the heat-radiating case and then transferred to the second refrigerant that passes through the inside of the heat-radiating case, and emitted from the heat-radiating case. Accordingly, the heat sink can absorb the heat generated from the battery cells and rapidly emit the absorbed heat so as to prevent the battery cells from deterioration.

Moreover, the heat-radiating case circulates the first and second refrigerants such that the first refrigerant is circulated at a speed lower than a circulation speed of the second refrigerant to absorb heat generated from the battery cells and rapidly radiate the absorbed heat, thereby restraining the battery cells from deterioration. That is, it is possible to induce the heat generated from the battery cells to be sufficiently transferred to the first refrigerant through the heat-radiating case by setting the circulation speed of the first refrigerant to be lower than that of the second refrigerant. Furthermore, it is possible to set the circulation speed of the second refrigerant to be higher than that of the first refrigerant to transfer the heat moved to the first refrigerant to the second refrigerant that passes through the inside of the heat-radiating case containing the first refrigerant, thereby rapidly radiate the heat to the outside of the battery cells. Accordingly, the heat generated from the battery cells can be rapidly radiated to prevent the battery cells from deterioration.

It will be appreciated by persons skilled in the art that the effects that could be achieved with the present invention are not limited to what has been particularly described hereinabove and other advantages of the present invention will be more clearly understood from the following detailed description.

### BRIEF DESCRIPTION OF THE DRAWINGS

FIG. 1 shows a battery cell module for electric vehicles according to an embodiment of the present invention.

FIG. 2 is an exploded perspective view showing a structure in which a heat sink is interposed between a pair of battery cells shown in FIG. 1.

FIG. 3 is an exploded perspective view showing the heat sink of the battery cells for electric vehicles shown in FIG. 2.

FIG. 4 is an exploded perspective view showing a heat sink of a battery cell for electric vehicles according to another embodiment of the present invention.

FIG. 5 shows a battery cell module for electric vehicles according to another embodiment of the present invention.

### DETAILED DESCRIPTION OF THE INVENTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

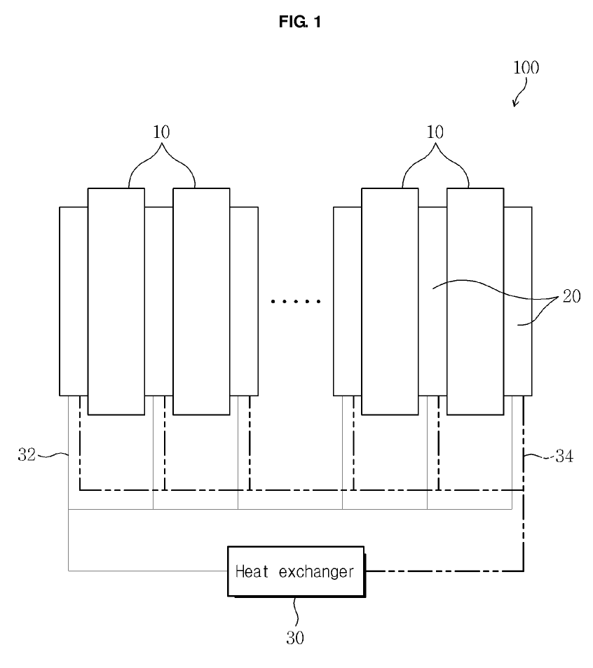

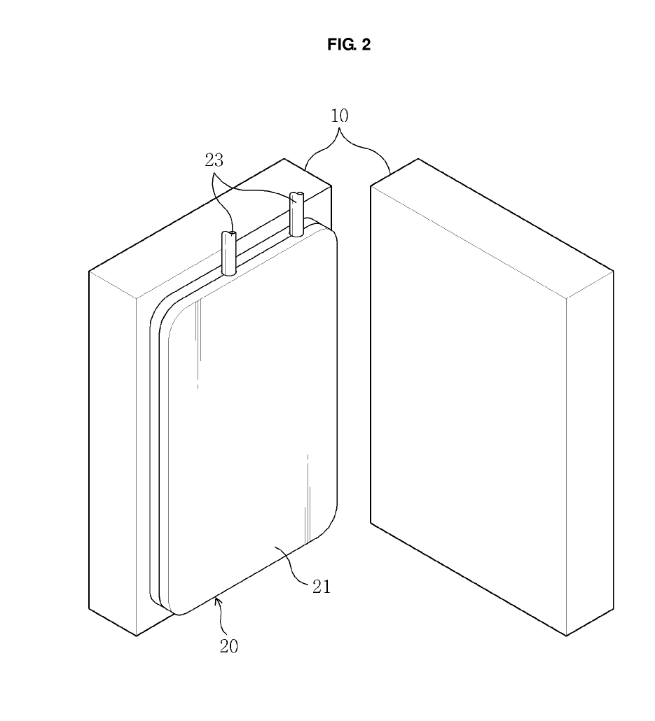

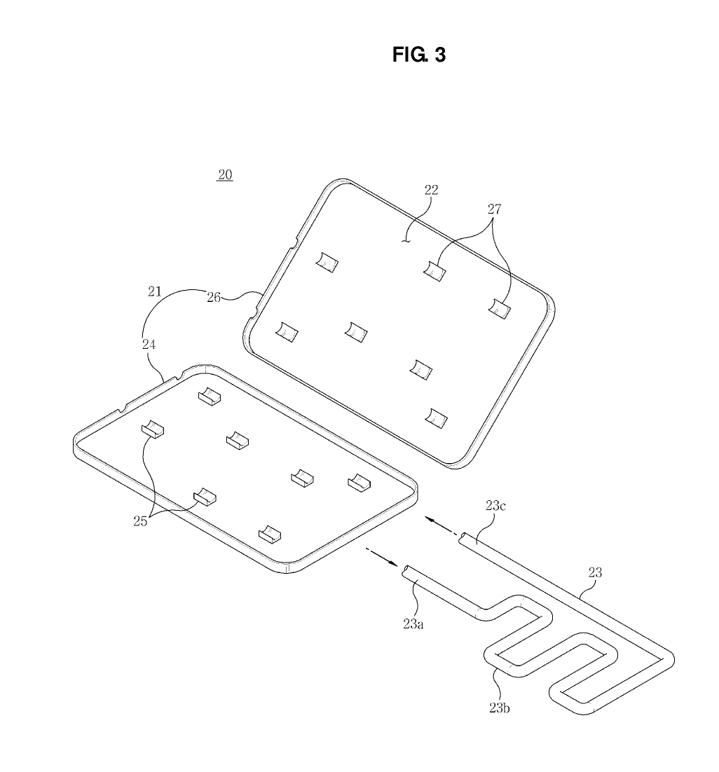

FIG. 1 shows a battery cell module 100 for electric vehicles according to an embodiment of the present invention, FIG. 2 is an exploded perspective view showing a structure in which a heat sink is interposed between a pair of battery cells shown in FIG. 1, and FIG. 3 is an exploded perspective view showing the heat sink of the battery cells for electric vehicles shown in FIG. 2.

Referring to FIGS. 1, 2 and 3, the battery cell module 100 according to an embodiment of the present invention includes a plurality of battery cells 10 and a plurality of heat sinks 20 each of which is interposed between neighboring battery cells 10. The battery cell module 100 may further include a heat exchanger 30 that performs a heat exchange for a circulating refrigerant.

The battery cells 10 have a plate shape and are arranged in at predetermined intervals and connected in series or parallel. Each battery cell 10 is configured in the form of an electrode assembly having an anode, a membrane and a cathode, which is housed in and protected by a battery case formed from a laminate sheet including a resin film and a metal film. An anode terminal and a cathode terminal electrically connected to the anode and cathode respectively are projected from both sides of the battery case. In addition, both sides of the plate-shaped electrode assembly of the battery cell 10 are exposed to the outside. Here, a secondary battery such as a nickel-metal hydride battery, lithium-ion battery or the like may be used as the battery cell 10.

Each of the heat sinks 20 is interposed between neighboring battery cells 10 and is in contact with both sides of the battery cells 10 to cool the battery cells 10 using a heat transfer according to mechanical contact and refrigerant circulation. At this time, the heat sinks 20 may be arranged such that they come into contact with the outer sides of the two outermost battery cells 10.

The heat exchanger 30 is connected to the heat sinks 20 to circulate a refrigerant and performs a heat exchange of the circulating refrigerant. Here, the heat exchanger 30 supplies the heat-exchanged refrigerant to the heat sinks 20 through an injection pipe 32, receives heated refrigerant from the heat sinks 20 through a return pipe 34 and perform a heat exchange. The heat exchanger 30 may use an air-cooling or water-cooling method as a heat exchange method.

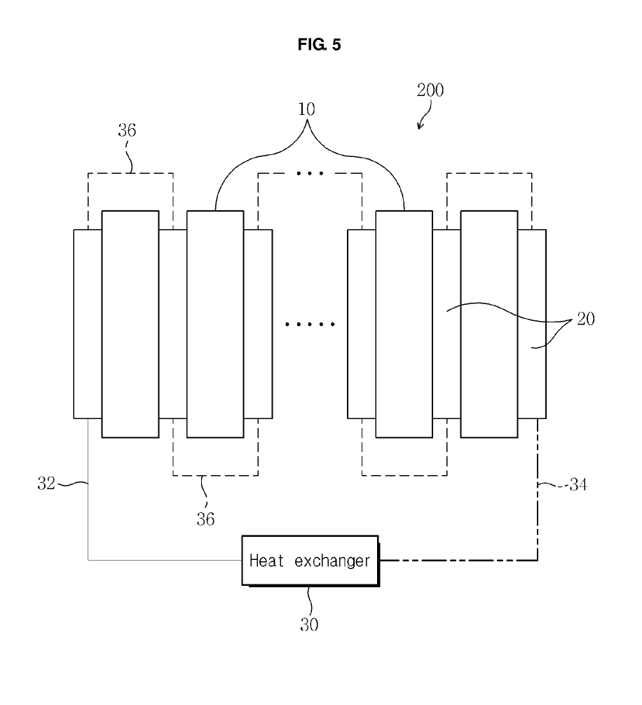

While the heat exchanger 30 is connected in parallel with the heat sinks 20 via the injection pipe 32 and the return pipe 34 in this embodiment, the present invention is not limited thereto. For example, the heat exchanger 30 and the heat sinks 20 can be connected in series, as shown in FIG. 5. That is, the heat exchanger 30 of a battery cell module 200 according to another embodiment of the present invention is connected with the outermost heat sink 20 on one side of the heat sink array via the injection pipe 32. The heat sinks 20 are serially connected via connecting pipe 36. The heat exchanger 30 is connected with the outermost heat sink 20 on the other side of the heat sink array via the return pipe 34. Here, the connecting pipe 36 may be arranged in the longitudinal direction or horizontal direction of the battery cells 10 depending on the direction of a refrigerant path formed in the heat sinks 20.

The heat sinks 20 according to the current embodiment absorb heat generated from the battery cells 10 using a plurality of refrigerants and rapidly emit the absorbed heat. Specifically, each heat sink 20 includes a heat-radiating case 21 and a second refrigerant circulating pipe 23. The heat-radiating case 21 is attached to a side of a neighboring battery cell 10 and its inner space 22 is filled with a first refrigerant. The second refrigerant circulating pipe 23 is arranged in the inner space 22 of the heat-radiating case 21, and a second refrigerant cools the first refrigerant while circulating in the second refrigerant circulating pipe 23.

The first and second refrigerants may use air, water, antifreeze, antifreeze-added water, Freon refrigerant, a natural refrigerant, a liquefied gas, etc. For example, one of water, antifreeze, and antifreeze-added water can be used as the first refrigerant and one of air, water, antifreeze, antifreeze-added water, Freon refrigerant, natural refrigerant, and liquefied gas can be used as the second refrigerant.

The heat-radiating case 21 includes a lower case 24 and an upper case 26 which form the inner space 22. The edges of the lower case 24 and the upper case 26 may be sealed by brazing. The first refrigerant may be injected into the inner space 22 of the heat-radiating case 21 through an injection hole (not shown) formed at one side of the heat-radiating case 21 and filled in the inner space 22. Here, the heat-radiating case 21 can be made of any material that has satisfactory thermal conductivity and, for example, a metal such as aluminum, copper, or an alloy of them, which has high thermal conductivity, can be used as the material of the heat-radiating case 21.

While the area of the heat-radiating case 21, which is in contact with both side of the battery cell 10, is smaller than the area of both sides of the battery cell 10 in the current embodiment, the present invention is not limited thereto. The contact area of the radiating-radiating case 21 may be equal to or larger than the area of both sides of the battery cell 10. Furthermore, a plurality of protrusions for extending a contact area of the heat-radiating case 21 with air may be formed on edges of the heat-radiating case 21, which are in proximity to both sides of the heat-radiating case 21 in contact with both sides of the battery cell 10.

A plurality of supports 25 for supporting the second refrigerant circulating pipe 23 is formed on the inner bottom faces of the lower case 24 and the upper case 26. The supports 25 are discontinuously arranged along a line on which the second refrigerant pipe 23 is arranged and support the second refrigerant pipe 23 set in the inner space 22 of the heat-radiating case 21. Here, the top faces of the supports 25 coming into contact with the second refrigerant circulating pipe 23 may be recessed corresponding to the outer side of the second refrigerant circulating pipe 23 such that the top faces of the supports 25 can stably come into contact with the outer side of the second refrigerant circulating pipe 23 to support the second refrigerant circulating pipe 23.

While the supports 25 are formed on the inner bottom face of both the lower case 24 and the upper case 25 in the current embodiment, the present invention is not limited thereto. For example, the supports 25 can be formed in any of the lower case 24 and the upper case 26 to support the second refrigerant circulating pipe 23. At this time, the supports 25 may fix and support the second refrigerant circulating pipe 23 in a fitting manner. Otherwise, the supports 25 may be formed on the surface of the second refrigerant circulating pipe 23.

The second refrigerant circulating pipe 23 may include an inlet 23a, a cooling pipe 23b and an outlet 23c. The inlet 23a is a portion through which the second refrigerant is injected into the second refrigerant circulating pipe 23. The cooling pipe 23b is connected with the inlet 23a and located in the inner space 22 of the heat-radiating case 21. A heat exchange occurs between the second refrigerant injected through the inlet 23a and the first refrigerant filled in the heat-radiating case 21. The outlet 23c is connected to the cooling pipe 23b and discharges the second refrigerant that has passed through the inside of the heat-radiating case 21 to the outside of the heat-radiating case 21. Here, the inlet 23a is connected to one end of the cooling pipe 23b and the outlet 23c is connected to the other end of the cooling pipe 23b. The inlet 23a, the cooling pipe 23b and the outlet 23c may be formed in one body. The inlet 23a is connected to the heat exchanger 30 via the injection pipe 32, receives the heat-exchanged second refrigerant from the heat exchanger 30 and transfers the second refrigerant to the cooling pipe 23b. The outlet 23c is connected to the heat exchanger 30 via the return pipe 34 and transmits the heated second refrigerant to the heat exchanger 30. The cooling pipe 23 may be arranged in a bending manner in the inner space 22 of the heat-radiating case 21 such that a contact area of the cooling pipe 23b and the first refrigerant filled in the heat-radiating case 21 is widened to achieve rapid a heat exchange. The second refrigerant circulating pipe 23 can be made of any material having satisfactory heat conductivity. For example, a metal having high heat conductivity, such as aluminum, copper, an alloy thereof, or the like, can be used as the material of the second refrigerant circulating pipe 23.

In the battery cell module 100 according to an embodiment of the present invention, as described above, the heat sink 20 is arranged between neighboring battery cells 10 and uses the first and second refrigerants to absorb heat generated from the battery cells 10 and rapidly radiate the absorbed heat, thereby restraining the battery cells 10 from deterioration. That is, the heat sink 20 has a structure in which the first refrigerant is filled in the heat-radiating case 21 and a flow path through which the second refrigerant can be circulated is formed according to the second refrigerant circulating pipe 23 in the heat-radiating case 21, and thus heat generated from the battery cells 10 is transferred to the first refrigerant through the heat-radiating case 21 and then transferred to the second refrigerant that passes through the inside of the heat-radiating case 21, and emitted from the heat-radiating case 21. Accordingly, the heat sink 20 can absorb the heat generated from the battery cells 10 and rapidly emit the absorbed heat so as to prevent the battery cells 10 from deterioration.

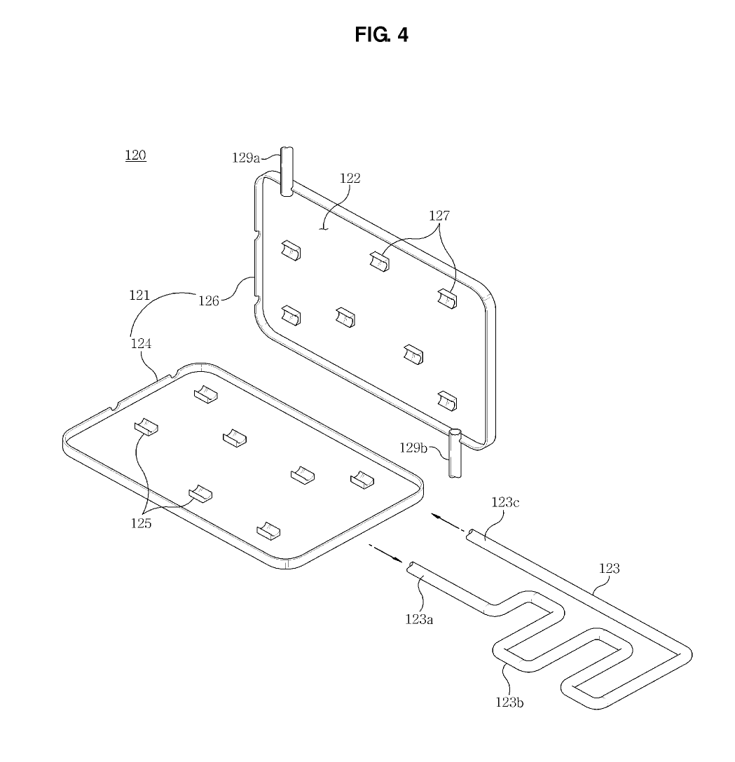

While the heat sink 20 of the battery cell module 100 has the heat-radiating case 21 filled with the first refrigerant in the current embodiment, the present invention is not limited thereto. For example, the first refrigerant filled in an inner space 122 of a heat-radiating case 121 can be circulated, as shown in FIG. 4.

FIG. 4 is an exploded perspective view of a heat sink 120 of a battery cell for electric vehicles according to another embodiment of the present invention.

Referring to FIG. 4, the heat sink 120 according to another embodiment of the invention includes the heat-radiating case 121, a first refrigerant circulating pipe 129, and a second refrigerant circulating pipe 123. The heat-radiating case 121 is attached to sides of neighboring battery cells 10 and the inner space 122 thereof is filled with the first refrigerant. The first refrigerant circulating pipe 129 circulates the first refrigerant filled in the heat-radiating case 121. The second refrigerant circulating pipe 123 is arranged in the heat-radiating case 121 and cools the second refrigerant circulating therein.

Since the heat sink 120 according to another embodiment of the present invention has the same structure as that of the heat sink (20 shown in FIG. 2) according to the above-described embodiment except that the heat sink 120 further includes the first refrigerant circulating pipe 129, detailed explanations of the heat-radiating case 121 and the second refrigerant circulating pipe 123 are omitted and the following description is concentrated on the first refrigerant circulating pipe 129.

The first refrigerant circulating pipe 129 includes an inlet 129a, connected to the heat-radiating case 121, through which the first refrigerant heat-exchanged is injected into the inner space 122 of the heat-radiating case 121, and an outlet 129b, connected to the heat-radiating case 121, through which the first refrigerant that has passed through the inner space 122 of the heat-radiating case 121 is discharged to the outside of the heat-radiating case 121. Here, the inlet 129a is connected to a heat exchanger via an injection pipe, receives the heat-exchanged first refrigerant from the heat exchanger and transfers the first refrigerant to the inside of the heat-radiating case 121. The outlet 129b is connected to the heat exchanger via a return pipe and delivers the heated first refrigerant to the heat exchanger. Here, the inlet 129a may be formed at an upper portion of the edge of the heat-radiating case 121 such that the first refrigerant evenly passes through the inner space 122 of the heat-radiating case 121. The outlet 129b may be formed at a lower portion of the edge of the heat-radiating case 121. The inlet 129a and the outlet 129b may be formed at the edge of the heat-radiating case 121 at a long distance from each other as far as possible.

The heat exchanger performs a heat exchange for both the first and second refrigerants and may respectively include injection pipes and return pipes for circulating the first and second refrigerants. Here, when the first and second refrigerants are identical to each other, the first and second refrigerants can share an injection pipe and a return pipe.

Furthermore, the heat-radiating case 121 circulates the first and second refrigerants such that the first refrigerant is circulated at a speed lower than a circulation speed of the second refrigerant to absorb heat generated from the battery cells and rapidly radiate the absorbed heat, thereby restraining the battery cells from deterioration. That is, it is possible to induce the heat generated from the battery cells to be sufficiently transferred to the first refrigerant through the heat-radiating case 121 by setting the circulation speed of the first refrigerant to be lower than that of the second refrigerant. Furthermore, it is possible to set the circulation speed of the second refrigerant to be higher than that of the first refrigerant to transfer the heat moved to the first refrigerant to the second refrigerant that passes through the inside of the heat-radiating case 121 containing the first refrigerant, thereby rapidly radiate the heat to the outside of the battery cells. Accordingly, the heat generated from the battery cells can be rapidly radiated to prevent the battery cells from deterioration.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A heat sink of a battery cell having a plate shape for electric vehicles, comprising:
a heat-radiating case attached to at least one side of the battery cell and filled with a first refrigerant; and
a second refrigerant circulating pipe arranged in the heat-radiating case and configured to circulate a second refrigerant for cooling the first refrigerant.

2. The heat sink of claim 1, further comprising:
a plurality of supports located between the inner side of the heat-radiating case and the second refrigerant circulating pipe and discontinuously arranged along the second refrigerant circulating pipe to support the second refrigerant circulating pipe.

3. The heat sink of claim 1, wherein the first and second refrigerants include at least one of air, water, antifreeze, antifreeze-added water, a Freon refrigerant, a natural refrigerant, and a liquefied gas.

4. The heat sink of claim 1, wherein the second refrigerant circulating pipe includes:
an inlet through which the second refrigerant is injected;
a cooling pipe connected to the inlet and arranged in the heat-radiating case, wherein a heat exchange occurs between the second refrigerant injected through the inlet and the first refrigerant filled in the heat-radiating case; and
an outlet connected to the cooling pipe and allowing the second refrigerant passing through the cooling pipe to be discharged to the outside of the heat-radiating case.

5. The heat sink of claim 1, further comprising:
a first refrigerant circulating pipe configured to circulate the first refrigerant filled in the heat-radiating case.

6. The heat sink of claim 5, wherein the first refrigerant circulating pipe includes:
an inlet connected to the heat-radiating case and allowing the first refrigerant to be injected into the heat-radiating case; and
an outlet connected to the heat-radiating case and allowing the first refrigerant to be discharged to the outside of the heat-radiating case.

7. The heat sink of claim 6, wherein a circulation speed of the second refrigerant is higher than that of the first refrigerant.

8. A battery cell module for electric vehicles, comprising:
a plurality of battery cells arranged at predetermined intervals and connected in parallel or series to each other; and
a plurality of heat sinks each of which is arranged between the battery cells,
wherein each of the heat sinks includes:
a heat-radiating case attached to at least one side of each battery cell and filled with a first refrigerant; and
a second refrigerant circulating pipe arranged in the heat-radiating case and configured to circulate a second refrigerant for cooling the first refrigerant.

9. The battery cell module of claim 8, further comprising:
a heat exchanger connected to the heat sinks, configured to circulate the second refrigerant, and performing a heat exchange for the circulated second refrigerant.

10. The battery cell module of claim 9, further comprising:
a first refrigerant circulating pipe configured to circulate the first refrigerant filled in the heat-radiating case,
wherein the heat exchanger performs a heat exchange for the first refrigerant.
